(19) United States
(12) Patent Application Publication
(10) Pub. No.: US 2022/0293300 A1
(43) Pub. Date: Sep. 15, 2022

(54) MODULAR, DEPLOYABLE CABLE MANUFACTURING MACHINE AND METHOD FOR USING THE SAME

(71) Applicants: Horst Moll, Houston, TX (US); Robert L. Schriefer, Katy, TX (US); Marc R. Quenneville, Mobile, AL (US); Erik Wiik, Katy, TX (US); Alan Roy Cordy, Katy, TX (US)

(72) Inventors: Horst Moll, Houston, TX (US); Robert L. Schriefer, Katy, TX (US); Marc R. Quenneville, Mobile, AL (US); Erik Wiik, Katy, TX (US); Alan Roy Cordy, Katy, TX (US)

(73) Assignee: Sea Cable Inc., Houston, TX (US)

(21) Appl. No.: 17/686,374

(22) Filed: Mar. 3, 2022

Related U.S. Application Data
(60) Provisional application No. 63/157,570, filed on Mar. 5, 2021.

(51) Int. Cl. H01B 13/00; B29C 48/06; B29C 48/154; H01B 9/00; H01B 7/14; H01B 13/14

(52) U.S. Cl. CPC H01B 13/0036; B29C 48/06; B29C 48/154; H01B 9/00; H01B 7/14; H01B 13/0003; H01B 13/14; B29K 2705/00

(57) ABSTRACT

A modular, deployable marine power cable manufacturing system and method for using the same. The system can include an inlet spooling module configured to receive a plurality of baskets and/or reels, each basket and/or reel of the plurality of baskets and/or reels can contain an elongated element. The system can include a gathering module comprising a matrix plate and a mandrel configured to gather the elongated elements into a bundle, a winding module comprising a static plate and a revolving plate configured to twist the bundle in an alternating helical configuration, a banding machine configured wrap a band or tape around the bundle and a caterpillar tractor configured to pull the bundle along the longitudinal axis. The inlet spooling module, the gathering module, the winding machine, the banding machine, and the caterpillar tractor can be configured to be disposed on a plurality of deployable modules.

### CROSS REFERENCE TO RELATED APPLICATION

This application claims priority to U.S. Provisional Application No. 63/157,570 filed on Mar. 5, 2021, which is incorporated by reference herein.

### FIELD

The present invention relates to marine power cables for the renewable energy industry. More specifically, the embodiments of the present invention relate to systems and methods for the manufacture and of marine power cables for the offshore wind energy industry.

### BACKGROUND

In the offshore wind energy industry, marine power cables are used to connect offshore wind turbines to the onshore electrical grid to transmit the generated electrical energy to the onshore electrical grid.

A marine power cable can comprise a number of power cables, electrical wires, optical conduits, filler strings and one or more protective or armor layers. The power cables, electrical wires, optical conduits, filler strings are typically gathered in a bundling or closing machine.

The traditional method of manufacturing marine power cables is performed at a brick and mortar, i.e., stationary, cable manufacturing facility that typically requires a large area and permanent equipment where the individual cables and wires are manufactured. The dimensions, weights, and distances from the cable manufacturing facility to the final installation site of the marine power cable can make the transport and storage of marine power cables from the manufacturing site to the installation site difficult, typically requiring special purpose transport vessels and thus expensive especially when the final location of installation of the marine power cable located at great distances from the manufacturing facility. Manufacturing the marine power cables closer to the installation site can save considerable time, money and reduce risk.

There is a need, therefore, for an improved marine power cable manufacturing machine and method and for using the same.

### SUMMARY

A modular, deployable marine power cable manufacturing system for manufacturing a marine power cable and a method of manufacturing a marine power cable are provided.

The marine power cable can include a plurality of elongated elements. The modular, deployable marine power cable manufacturing system can be arranged in the following component sequence along a longitudinal axis and can include an inlet spooling module, a gathering module, a winding module, a first banding machine, and a caterpillar tractor. The inlet spooling module can be configured to receive a plurality of baskets and/or a plurality of reels. Each basket and/or reel of the plurality of baskets and/or reels can include an elongated element. The inlet spooling module, the reels and/or the baskets can be configured to deploy the elongated elements. The gathering module can comprise a matrix plate and a mandrel. The matrix plate can define a plurality of openings configured to receive and direct the elongated elements towards the mandrel and the mandrel can be configured to circumscribe and gather the plurality of elongated elements into a bundle such that the plurality of elongated elements can be substantially parallel to and adjacent to one another. The winding module can include a static plate and a revolving plate configured to twist the bundle in an alternating helical configuration. The first banding machine can be configured to wrap a band or tape around the bundle. The caterpillar tractor can be configured to pull the bundle along the longitudinal axis. The inlet spooling module, the gathering module, the winding machine, the first banding machine, and the caterpillar tractor can be configured to be disposed on a plurality of deployable modules.

A method for manufacturing a marine power cable can include deploying a modular, deployable marine power cable manufacturing system to a construction site. The modular, deployable marine power cable manufacturing system can be arranged in the following component sequence along a longitudinal axis and can include an inlet spooling module, a gathering module, a winding module, a first banding machine, and a caterpillar tractor. The inlet spooling module can be configured to receive a plurality of baskets and/or a plurality of reels. Each basket and/or reel of the plurality of baskets and/or reels can include an elongated element. The inlet spooling module, the reels and/or the baskets can be configured to deploy the elongated elements. The gathering module can comprise a matrix plate and a mandrel. The matrix plate can define a plurality of openings configured to receive and direct the elongated elements towards the mandrel and the mandrel can be configured to circumscribe and gather the plurality of elongated elements into a bundle such that the plurality of elongated elements can be substantially parallel to and adjacent to one another. The winding module can include a static plate and a revolving plate configured to twist the bundle in an alternating helical configuration. The first banding machine can be configured to wrap a band or tape around the bundle. The caterpillar tractor can be configured to pull the bundle along the longitudinal axis. The inlet spooling module, the gathering module, the winding machine, the first banding machine, and the caterpillar tractor can be configured to be disposed on a plurality of deployable modules; loading a plurality of baskets and/or reels containing a plurality of elongated elements into the inlet spooling module; routing the plurality of elongated elements from the baskets and/or reels through the plurality of openings defined by the matrix plate; routing the plurality of elongated elements through the mandrel to gather the elongated elements into a bundle; moving the bundle in a direction towards the caterpillar tractor; twisting the bundle into an alternating helical configuration; and wrapping a helically wound tape or banding material around the outside of the bundle.

### BRIEF DESCRIPTION OF THE DRAWINGS

FIG. 1 depicts a cross sectional view of a marine power cable having a plurality of power cables, at least one armor layer, a plurality of filler strings, an optional fiber optic bundle and an outer jacket.

FIG. 2 depicts a cross sectional view of a marine power cable having a plurality of power cables, at least one armor layer, a plurality of filler strings, an optional fiber optic bundle, an outer jacket, and a plurality of longitudinal strength elements.

FIG. 3 depicts an illustrative modular deployable marine power cable manufacturing system in plan view according to one or more embodiments described.

FIG. 4 depicts an illustrative inlet spooling module in plan view with baskets according to one or more embodiments described.

FIG. 5 depicts an illustrative inlet spooling module in plan view with reels according to one or more embodiments described.

FIG. 6 depicts an illustrative gathering module in an isometric view with matrix plates according to one or more embodiments described.

FIG. 7 depicts an illustrative gathering module in an isometric view with tubular conduits according to one or more embodiments described.

FIG. 8 depicts an illustrative winding module in an isometric view according to one or more embodiments described.

FIG. 9 depicts an illustrative banding module in an isometric view according to one or more embodiments described.

FIG. 10 depicts an illustrative planetary winding module in an isometric view according to one or more embodiments described.

FIG. 11 depicts an illustrative jacket module in an isometric view according to one or more embodiments described.

FIG. 12 depicts an illustrative caterpillar tractor module in an isometric view according to one or more embodiments described.

FIG. 13 depicts an illustrative collection and deployment module configured as a vertical reel in an isometric view according to one or more embodiments described.

FIG. 14 depicts an illustrative collection and deployment module configured as a horizontal carousel in an isometric view according to one or more embodiments described.

FIG. 15 depicts an illustrative collection and deployment module configured as a basket carousel in an isometric view according to one or more embodiments described.

FIG. 16 depicts an illustrative modular deployable marine power cable manufacturing system in plan view according to one or more embodiments described.

FIG. 17 depicts an illustrative winding module having a guide and a taping machine in an isometric view according to one or more embodiments described.

FIG. 18 depicts a method for manufacturing a marine power cable according to some embodiments.

### DETAILED DESCRIPTION

The various aspects and advantages of the preferred embodiment of the present invention will become apparent to those skilled in the art upon an understanding of the following detailed description of the invention, read in light of the accompanying drawings which are made a part of this specification.

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.” Additionally, the term “substantially parallel” should be interpreted to mean that a distance between centerlines or longitudinal axis' of two or more members or elements generally or on average does not vary over the length of the members or elements but minor variations or changes in the distance between centerlines or longitudinal axis' over short lengths of the members or elements can be tolerated or expected without compromising on the term “substantially parallel”.

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

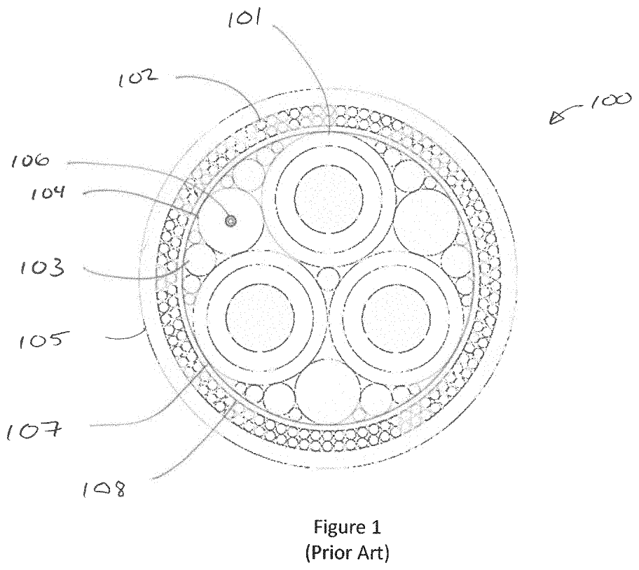

FIG. 1 depicts a cross sectional view of an illustrative marine power cable 100 having a plurality of power cables 101, at least one armor layer 102, two are shown, a plurality of filler strings 103, an optional fiber optic bundle 104 and an outer jacket 105. The marine power cable 100 can include an electric wire, not shown. The power cables 101, filler strings 103, and the fiber optic bundle 104 can be gathered to form a bundle 107. A tape or band layer 108 can be wound around the power cables 101, filler strings 103 and the fiber optic bundle 104. The marine power cable 100 can have a number of power cables 101, three are shown. The fiber optic bundle 104 can include a plurality of optical conduits, 106. The power cables 101 can be medium or high voltage cables, for example infield cables can have ratings of 10-20 (kilovolt) kV, or 15-25 kV, or 30-35 kV, or 60-70 kV or in some embodiments even higher. The power cables 101 may include various types of insulation and can include one or more shielding layers to protect from electrical interference or water ingress according to known methods.

The filler strings, 103 can include a plurality of strings, yarns ropes constructed of a suitable material. The filler strings 103 can be of varying diameters. The filler strings 103 can be manufactured from any number of materials including relatively stiff poly vinyl chloride (PVC) material, plastic filler material, foam material, High-Density Polyethylene (HDPE), Low-Density Polyethylene (LDPE), Polypropylene (PP), Polyurethane (PU) other types of filler material that is known to those in the art. The filler strings 103 can include different strings having different diameters and different materials according to some embodiments. The filler strings 103 can be located at least partly around and in between the power cables 101, to minimize contact stresses amongst the various elongated elements that may occur during transportation, installation and/or operational phases.

The armor layer 102 can comprise a plurality of steel wires, galvanized coated steel wires or other metallic or other material known to those skilled in the art that is sufficiently resistant to damage and/or corrosion. In some embodiments, the marine power cable can include a plurality of armor layers 102, two are shown. In other embodiments, the armor layer 102 can comprise a plurality of coated strings, not shown. The strings can be coated with a tar or bitumen material. The armor layer 102 can be wound around the, on the outside of the bundle, in a helical fashion in a helical arrangement. In some embodiments, a second armor layer can be wound around the bundle 107 or the exterior of a first armor layer 102 in a direction that is opposite the armor layer 102.

The optional fiber optic bundle 104 can include a plurality of fiber optic conduits, 106. The fiber optic conduits 106 can provide a data link to various wind turbine devices for the purposes of transmitting signals and/or data. In some embodiments, fiber optic conduits 106 may be included for a distributed temperature or other parameter monitoring (not shown).

The tape or banding layer 108 can be wound around the bundle 107 in a helical fashion. The tape or banding layer 108 can include a tape or band material that can be manufactured from a metallic material, or a synthetic material, for example polyester, Kevlar, Dacron, or other similar elements according to the strength requirements of the banding material.

The optional outer jacket 105 can comprise a plastic coating that can be continuously extruded on the outside of the armor layer 102. The outer jacket material may be selected from high density polyethene, medium density polyethene, a thermoset or thermoplastic material, cross-linked polyethylene material or other similar material well known to those in the art.

The outer jacket layer 105 can alternatively comprise of a layer of plurality of elongated elements such as polypropylene strings, similar to the filler strings 103, not shown wound in helical arrangement. These elongated elements may also optionally be coated with a suitable material such as tar or bitumen and are also wound around the armor layer using a planetary winding machine in a helical fashion.

The marine power cable 100 can also comprise an electric wire, not shown, that can be configured to conduct a low voltage electrical signal, for example 14 volts, or 28 volts, or even up to 440 volts or higher. The electric wire can be configured to transmit an Alternating Current (AC) electrical current or a Direct Current (DC) electrical current.

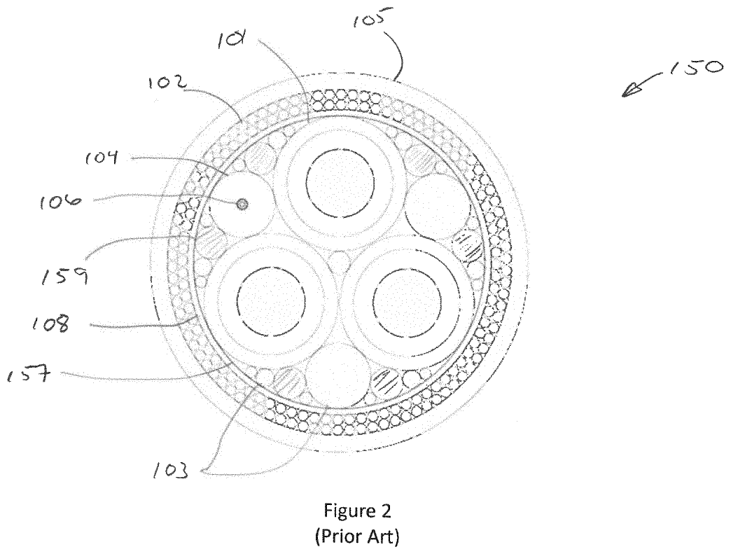

FIG. 2 depicts a cross sectional view of a marine power cable 150 with a plurality of power cables 101, three are shown, at least one armor layer 102, two are shown, a plurality of filler strings 103, longitudinal strength elements 159, six are shown, a fiber optic bundle 104, a tape layer 108, and an outer jacket 105. The power cables 101, the fiber optic bundle, 104, the plurality of filler strings 103 and the longitudinal strength elements 159 can be gathered to form a bundle 157. The fiber optic bundle 104 can include a plurality of optical conduits 106. The elongated strength elements 159 can be integrated into a marine power cable 150 that can experience or be subject to high tensile loading. These high tensile loads can occur temporarily or continuously and can be associated with relatively deep water. Deepwater can be waters more than 50 meters, from 50 meters to 100 meters, from 100 meters to 150 meters, 150 meters to 200 meters or water depths ranging from 200 meters up to 1000 meters. Temporary longitudinal loading can occur during installation activities while continuous loading is more common for deepwater applications. The elongated strength elements 159 can comprise of traditional wire rope, metallic rods, carbon fiber rods, or other suitable material with a high tensile capacity while having a low bending capacity. The elongated strength elements 159 can be wound into the bundle 157.

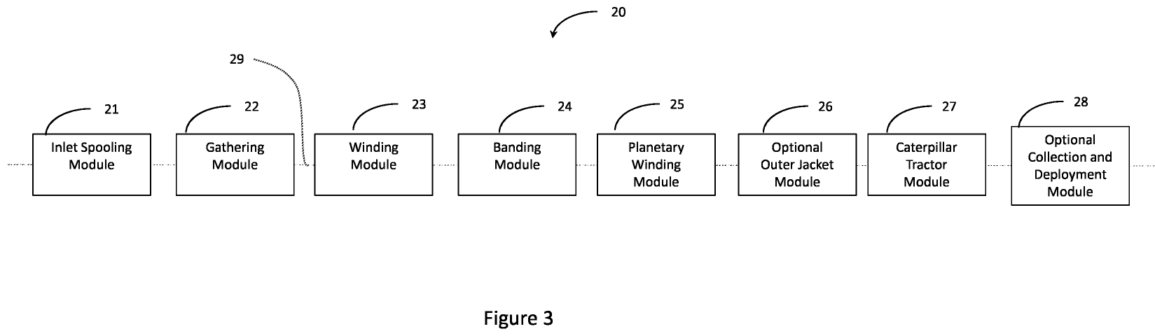

FIG. 3 depicts an illustrative modular, deployable marine power cable manufacturing system 20 in a schematic view according to one or more embodiments described. The modular deployable marine cable manufacturing system 20, or alternatively the system, can comprise any number of production modules or production machines arranged and distributed among a plurality of deployable modules and can also optionally comprise a number of foundation modules not shown on which the production modules can sit upon at a construction site. The modules can be arranged along a longitudinal axis 29 and are arranged in a particular order according to the specific marine power cable manufacturing sequence when deployed at the construction site. The various production modules can include an inlet spooling module 21, a gathering module 22, a winding module 23, a banding module 24, a planetary winding module 25, an optional outer jacket module 26, not shown, a caterpillar tractor module 27 and an optional collection and deployment module 28. The various production modules listed above can be arranged along the longitudinal axis 29 according to the component sequence or order listed. The various modules or machines can be configured on or as a skid, or in a standard shipping container such that they can be rapidly deployed to a manufacturing or construction site. The modules can then be arranged along a longitudinal axis 29, secured to the ground, power can be run to the various modules and in a short amount of time, the system can be ready to manufacture marine power cables. The modules can be configured to be transportable by standard trucks, for example a semi-tractor trailer.

The modular, deployable marine power cable manufacturing system 20 can be configured such that individual elongated elements can enter the system at the inlet spooling module 21 and subsequently move from module to module according to the component sequence listed for various steps of the manufacturing process described.

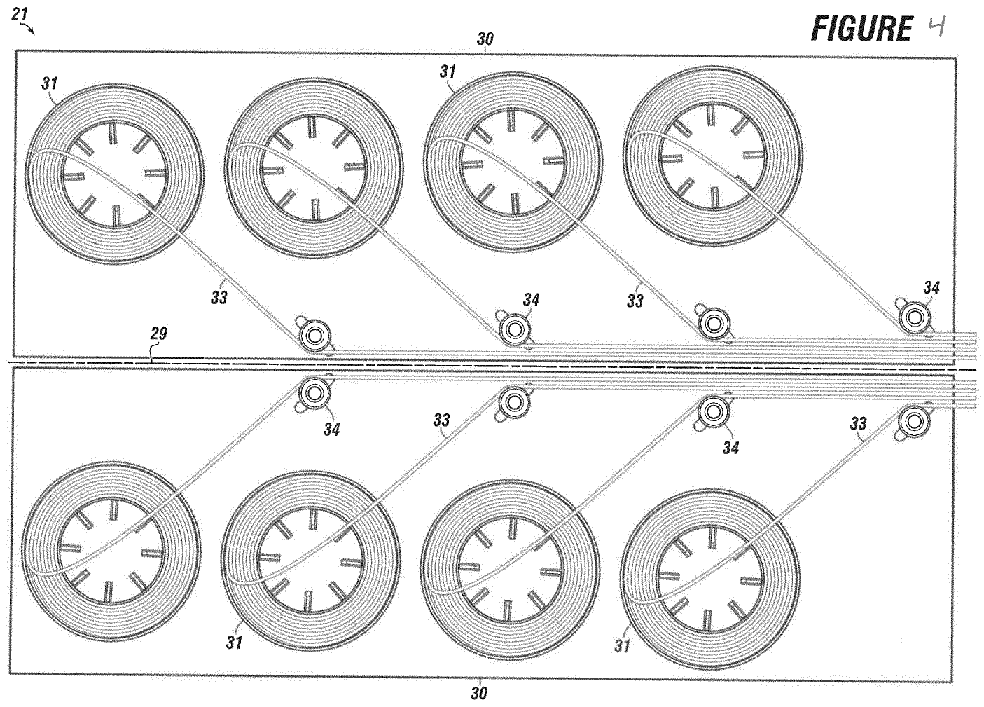

FIG. 4 depicts an illustrative inlet spooling module 21 in plan view including a plurality of baskets 31 according to one or more embodiments. The inlet spooling module 21 can include at least one, rack 30, two are shown, configured to receive a plurality of baskets 31 that can contain individual elongated elements 33. The inlet spooling module 21 can be the first module in the system 20. The baskets 31 can be orientated about a vertical axis and can or cannot be configured to rotate. Non-rotating baskets 31 can impart a twist on into the elongated element 33 when the elongated elements 33 are deployed towards the longitudinal axis 29. The inlet spooling module 21 can include at least one turning sheave, roller, or guide 34 that can be configured to direct, turn, or guide the elongated element 33 from the basket 31 towards the gathering module 22 substantially along the longitudinal axis 29 without imparting unacceptable bending loading on the elongated elements 32. The inlet spooling module 21 can be configured to deploy the elongated elements 33 towards the gathering module 22.

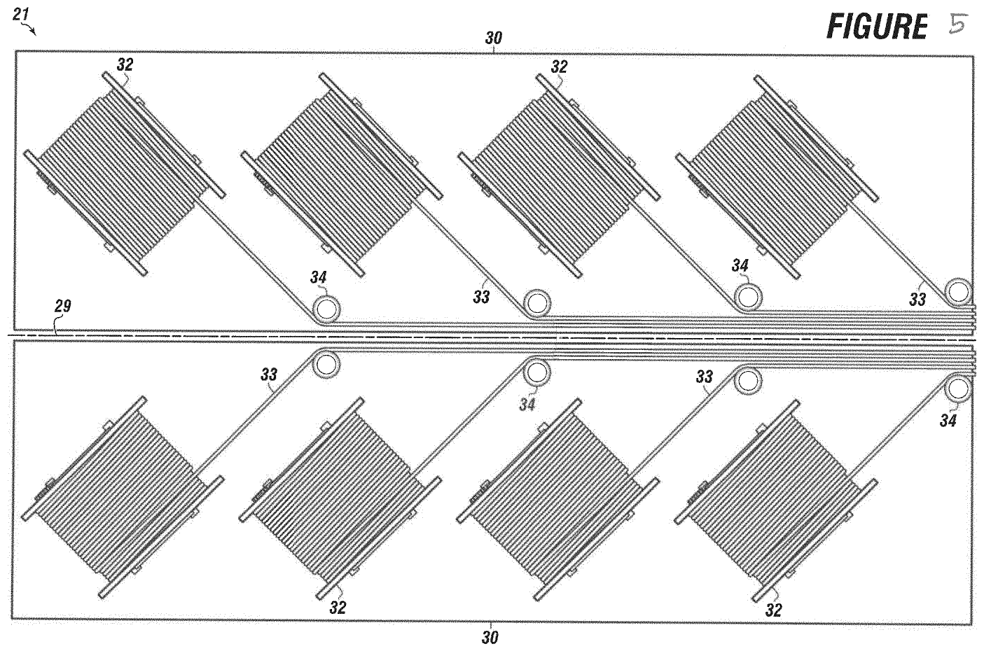

FIG. 5 depicts another illustrative inlet spooling module 21 in a plan view that includes a plurality of reels 32 according to one or more embodiments. The inlet spooling module 21 can include at least one, rack 30, two are shown, configured to receive a plurality of reels 31 that can contain individual elongated elements 33. The reels 32 can be orientated to rotate about a horizontal axis as shown and may not impart a twist into the elongated element 33 as the elongated elements 33 are deployed along the longitudinal axis 29. The plurality of reels 32 can contain the elongated elements 33 and can be orientated such that the elongated elements 33 are fed around a series of sheaves, rollers, or guides 34 of suitable dimensions to guide, orientate and urge the elongated elements towards the longitudinal axis 29 and the gathering module 22 without imparting unacceptable bending loads on the elongated elements 33. The inlet spooling module 21 can be configured to deploy the elongated elements 33 toward the gathering module 22.

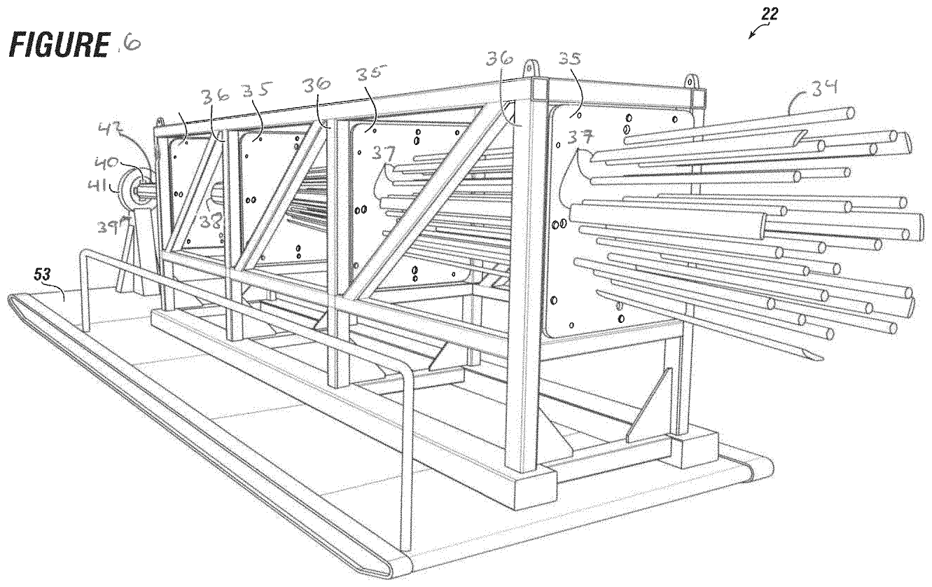

FIG. 6 depicts an illustrative gathering module 22 in an isometric view with matrix plates according to one or more embodiments. The gathering module 22 can be the next module in the system 20 and can include at least one matrix plate 35, but more typically a series of matrix plates 35 supported on a frame 36, three matrix plates 35 are shown. The matrix plates 35 each define a plurality of openings 37 arranged in a specified pattern that is particular to the marine power cable design that is being manufactured. When a plurality of matrix plates 35 are disposed on the gathering module 22, each subsequent matrix plate 35 can bring the elongated elements 34 closer together and into a preferred cross-sectional configuration. As the elongated elements 34 pass through the at least one matrix plates 35, the matrix plates 35 urge the elongated elements into the desired cross-sectional arrangement when viewed along the longitudinal axis 29. Subsequent to the last matrix plate 34, the gathering module 22 may comprise a mandrel 38 that circumscribes the plurality of elongated elements 34 and urges the plurality of elongated elements 34 into a bundle 42 wherein the plurality of elongated elements 34 are substantially parallel to and adjacent to one another. After the bundle 42 has been formed, the bundle 42 can pass through at least one optional guide 41, that can be supported on a stand 39. The guide 41 can include a plurality of rollers 40, three are shown, that can contact the outer surface of the bundle 42 to keep the elongated elements 34 that make up the bundle 42 adjacent to one another and can prevent the elongated elements 34 from separating from one another in a radial direction. The guide and plurality of matrix plates 41 can be disposed on a foundation module 53. In some embodiments, the guide 41 can be disposed on a stand-alone module of the module, not shown. The gathering module 22 can be disposed on a foundation module 53. The foundation module, 53 can be a structural e.g. steel skid, or frame that can be disposed on the ground at the construction site.

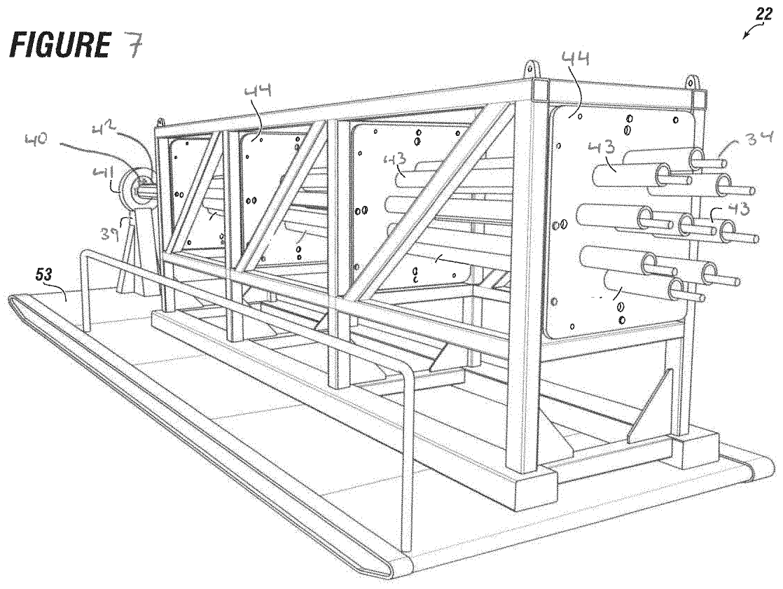

FIG. 7 depicts an illustrative gathering module 22 in an isometric view with tubular conduits 43 according to one or more embodiments. This embodiment of a gathering module 22 can include a plurality of tubes 43 arranged in a specified pattern that is particular to the marine power cable design that is being manufactured. The tubes 43 are arranged and configured such that they urge or direct the elongated elements 34 into a tighter pattern and into a bundle 42 that can have a cross section wherein the plurality of elongated elements 34 are substantially parallel to and adjacent to one another. The tubes 43 can be supported by a foundation module 53. Subsequent to the tubes 43, the gathering module may comprise a mandrel 38 that circumscribes the plurality of elongated elements 34 and urges the plurality of elongated elements 34 into a bundle 38. After the bundle 38 has been formed, the bundle 42 can pass through at least one guide, 41, that can be supported on a stand 39. In some embodiments, the guide 41 can be disposed on a stand-alone module of the module, not shown. The gathering module 22 can be disposed on a foundation module 53. The foundation module, 53 can be a structural e.g. steel skid, or frame that can be disposed on the ground at the construction site.

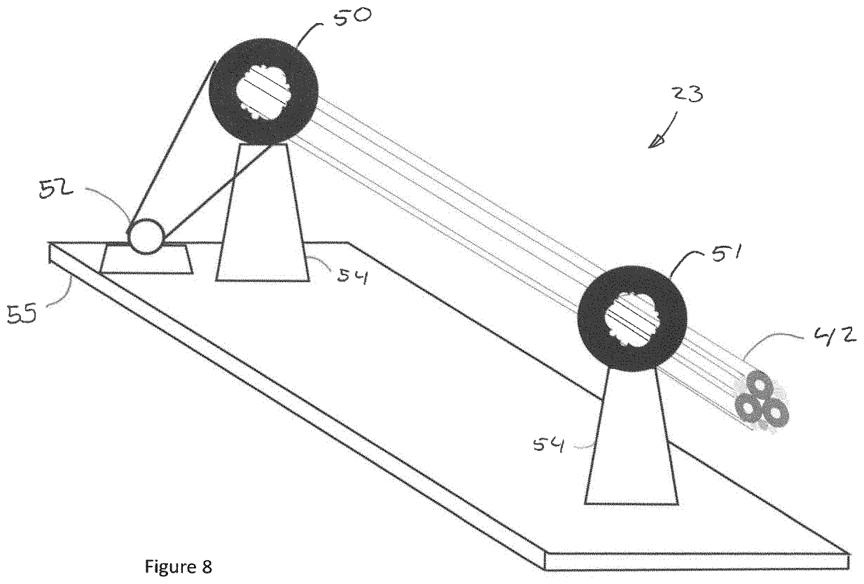

FIG. 8 depicts an illustrative winding module 23 in an isometric view according to one or more embodiments. The winding module 23 can be the next module in the system 20 after the gathering module 22 and the bundle 42 can advance from the gathering module 22 to the winding module 23. The winding module 23 can include a revolving plate 50 and a static plate 51. The revolving plate 50 and the static plate 51 can be oriented substantially perpendicular to the longitudinal axis 29. The revolving plate 50 and static plate 51 can each have an opening that is complementary to the cross-sectional shape of the bundle such that the revolving plate 50 and static plate 51, can impart a torsional force to rotate or twist the bundle 42. The revolving plate 50 can be fitted to an electrical, hydraulic motor or other means 52 of rotating or turning the revolving plate 50 relative to the static plate 51. The revolving plate 50 can be configured to revolve clockwise for a plurality of rotations, and then counterclockwise for a plurality of rotations in an alternating fashion thus winding the bundle 42 into an alternating helical configuration as the bundle 42 passes through the winding machine 23. Both the static plate 51 and revolving plate 50 can be mounted on stands or pedestals 54 within the winding module 23. The stands or pedestals 54 can be mounted on a deployable module 55. The revolving plate 50 can rotate at a rate that is known to those skilled in the art and commensurate with the selected design of the marine power cable being manufactured. Typical rotation or winding rates range from one revolution every 0.5 meters of cable length on up to one revolution every 3-5, or one revolution every 6-10 meters or greater depending upon the specific design of the marine power cable.

The process of winding or twisting the bundle 42 to create the helical or alternating helical configuration can impart loads or forces that can be significant, therefore the winding module can further comprise or be mounted on a modular and deployable module 55 to react to the forces generated during or by the winding operation. The deployable module 55 can be configured as a skid, or a fabricated, e.g. steel structure configured to provide a structural foundation to react and support the forces generated by winding or twisting the bundle 42 as well as being configured to be transported by conventional semi-tractor trailer. The winding module 23 can also include at least one guide, not shown but similar to the guide 41 of FIG. 7, that keeps the bundle 42 together radially.

FIG. 9 depicts an illustrative banding module 24 in an isometric view according to one or more embodiments. The banding module 24 can be the next module in system 20 after the winding module 23 and the bundle 42 can advance from the winding module 23 to the banding module 24. The banding module 24 can include a banding machine 60 that comprises at least one rotating tape or band dispenser 61, two are shown. The rotating tape or band dispenser 61 can apply a tape material or band material 62 around the circumference of the bundle 42 after it has been wound into helical configuration by the winding module 23. In some embodiments, the banding machine 60 and/or banding module 24 can be disposed immediately after and/or adjacent to the revolving plate 50. The banding machine 60 can be configured to be adjustable in terms of the tension and speed at which the tape or band 62 is applied to the bundle 42 so as to be capable of applying varying tensions and radial inward force on the bundle 42 such that the bundle does not unwind, twist, “birdcage” or otherwise deform in an undesirable way due to the internal residual loads or stresses acting on the elongated elements 33 of the bundle 42. The banding module 24 can also comprise at least one guide 41, one is shown. In some embodiments, the banding machine 60 can be configured within the bounds of adjacent modules, for example the winding module 23.

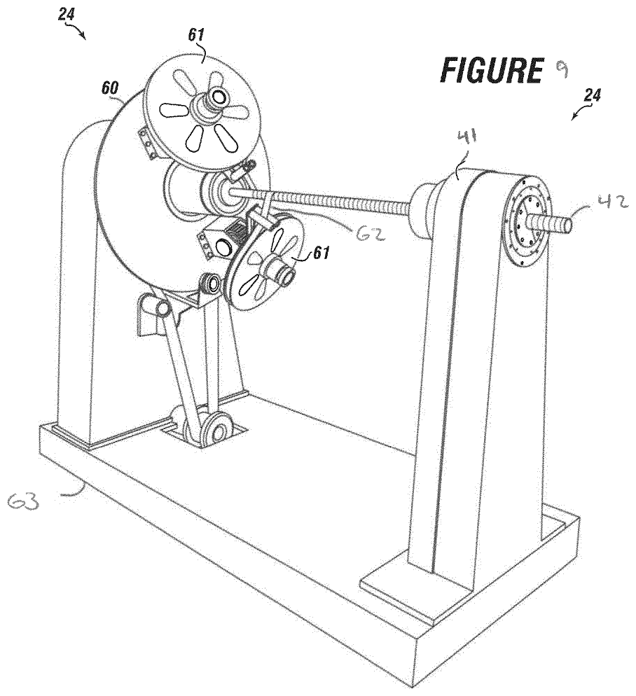

FIG. 10 depicts an illustrative planetary winding module 25 in an isometric view according to one or more embodiments. The planetary winding module 25 can be the next module in the system 20 after the first banding module 23 and the bundle 42 can advance from the first banding module 23 to the first planetary winding module 23.

The planetary winding module 25 can comprise a planetary winding machine 70. The planetary winding module 25 can be configured to apply a layer to the bundle 42. In some embodiments, the layer can comprise a plurality of strings or a plurality of metallic wires wound around the bundle 42 in a tight helical arrangement so as to provide a protection or armor layer, for example item 102 shown in FIG. 1 on an exterior surface of the bundle 42. By varying the speed at which the planetary winding machine 70 rotates around the bundle 42, the lay angle of the wires or strings can be varied. In some embodiments, a plurality of planetary winding modules 25 can be configured in series and can include a first planetary winding machine 70 and a second planetary winding machine 70. Each planetary winding machine can comprise a rotatable circular frame 71 connected to a turning device 75 via a chain, belt, drive shaft, rollers, gears, or other suitable drive linkage. The planetary winding machine 70 can have a longitudinal axis 76 that can be coincident with the longitudinal axis 29 of the system. A plurality of spools or bobbins 73 around which the armor elongated elements 102 are wound and deployed from can be mounted on the circular frame 71 such that the axis of rotation of the spool or bobbin 76 is perpendicular to the longitudinal axis so as to avoid twisting of the armor elongated elements 102 while they are being wound around the bundle 42 to form the layer. Also attached to the rotatable frame is at least one die 74 through which the bundle 42 pass. The die 74 positions the plurality of armor elongated elements in a desired orientation and spacing and can rotate with the rotatable frame 71 or be held in a static position on a pedestal 77. As the bundle 42 progresses through the planetary winding machine 70, the rotatable frame 71 can rotate about the longitudinal axis 76 at a selected rotational speed so as to wind the armor elongated elements into the desired helical shape or pattern on the outside of the bundle 42. In some embodiments, the planetary winding module 25 can comprise two planetary armor machines 70, not shown, one to wind a layer of bedding strings, and a second to wind a layer of metallic armor wires 102. In other embodiments, the system can include a first planetary winding machine 70 and a second planetary winding machine 70 each disposed on separate modules. The bedding strings can serve as a cushion between the bundle 42 and the armor wires 102. The bedding strings can comprise various types of strings including polypropylene, nylon, Dacron or other suitable material. In alternate embodiments, the two planetary winding machines 70 can each be configured on individual modules or combined with other elements of the system according to the specific application which will be apparent to those skilled in the art.

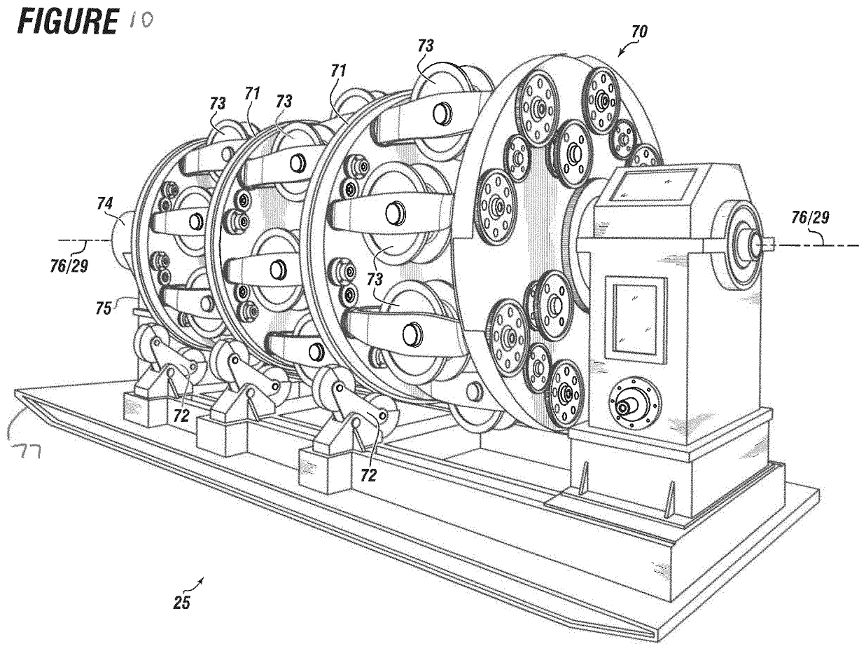

FIG. 11 depicts an illustrative outer jacket module 26 in an isometric view according to one or more embodiments. In some embodiments, the outer jacket module 26 can comprise a jacket extruding machine 80. In other embodiments, the jacket extruding machine 80 can be disposed on another module 26 together with another machine. In other embodiments, the system can exclude an outer jacket module 26. The outer jacket module 26 can be the next module in the system 20 after the planetary winding module 25 and the bundle 42 can advance from the first or second planetary winding module 25 outer jacket module 26.

The jacket extruding machine 80 can include a hopper 81 wherein jacket material pellets are loaded, a heating element 82 that heats the pellets to a temperature above their melting point, a pump 83 that pumps the liquid jacket material, an extruder head 84 that forms the fluid and formable jacket material around the bundle at a specified thickness, and an optional subsequent cooling element 85 comprising a water bath or water spay system that can cool the outer jacket to below its melting point after it exists the extruder head 84. The outer jacket module 26 can be disposed on a skid, or a fabricated frame, e.g., a steel frame, 86. In certain other embodiments, the outer jacket module 26 can be configured to apply the outer jacket layer, for example item 105 of FIG. 1.

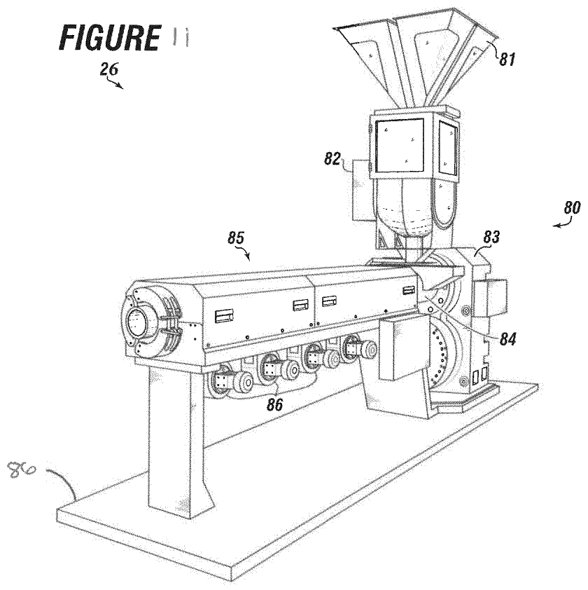

FIG. 12 depicts an illustrative caterpillar tractor module 27 in an isometric view according to one or more embodiments. The caterpillar tractor module 27 can be the next module in system 20 after the jacket module 26 and the bundle 42 can advance from the outer jacket module 26 to the caterpillar tractor module 27. A caterpillar tractor 90 can be configured to be disposed on the caterpillar tractor module 27 according to some embodiments. In some embodiments, the caterpillar tractor 90 is configured to grip the exterior of the bundle 42 or a completed marine power cable 100, 150 and pull it along the longitudinal axis 29 of the system towards the collection and deployment module 29. The caterpillar tractor 90 can be a two-track device, a three-track device or a four-track device depending upon the application. The caterpillar tractor 90 is dimensioned to not put excessive compressive loads on the bundle 42 or completed marine power cable 100, 150. Multiple caterpillar tractors 90 can be aligned in series in certain applications, not shown. In other embodiments, the caterpillar tractor 90 can be eliminated from the system. The caterpillar tractor 90 can include at least two tracks 91 as shown that can be driven by at least one drive motor 92, not visible. The caterpillar tractor 90 can be modularized and can disposed on a skid, or a fabricated frame, e.g., a steel frame, 93. The caterpillar tractor 90 can be configured with a variable speed controller mechanism, not shown.

The marine power cable 100 can be arranged in a coiled or bundled configuration for subsequent installation. The collection and deployment module 28 can provide a means of storing the completed marine power cable in a specific coiled configuration such that it can be directly deployed to an installation vessel.

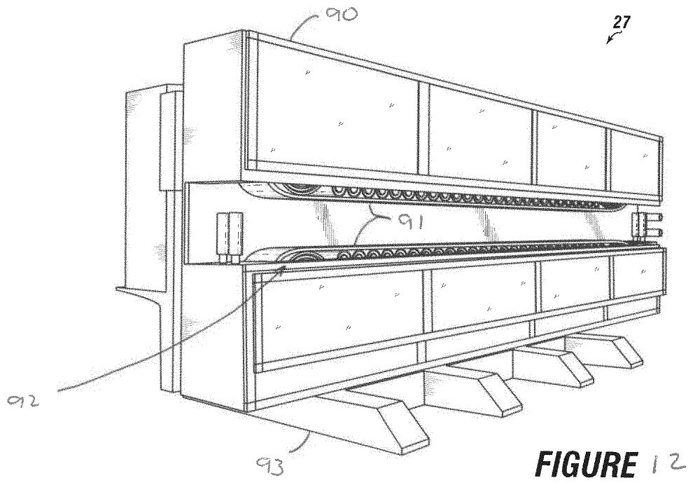

FIG. 13 depicts an illustrative collection and deployment module 28 configured as a vertical reel 90 in an isometric view according to one or more embodiments. Upon completion of the cable manufacturing process, the marine power cable 100 or 150 can be moved further to a collection and deployment module 28. The collection and deployment module 28 can provide a means of storing the completed marine power cable 100 or 150 in a specific coiled configuration such that it can be directly deployed to an installation vessel and subsequently installed at the site. In one embodiment, the marine power cable is manufactured directly to the collection and deployment module 28 without the use of a temporary storage devices. In some embodiments, the vertical reel 90 can have an under-roller system 91. In other embodiments, the vertical reel 90 can have a hub drive system, not shown. The under-roller system 91 comprises of a pair of rollers 92 that are driven by a hydraulic or electric motor 93 to rotate the horizontal reel.

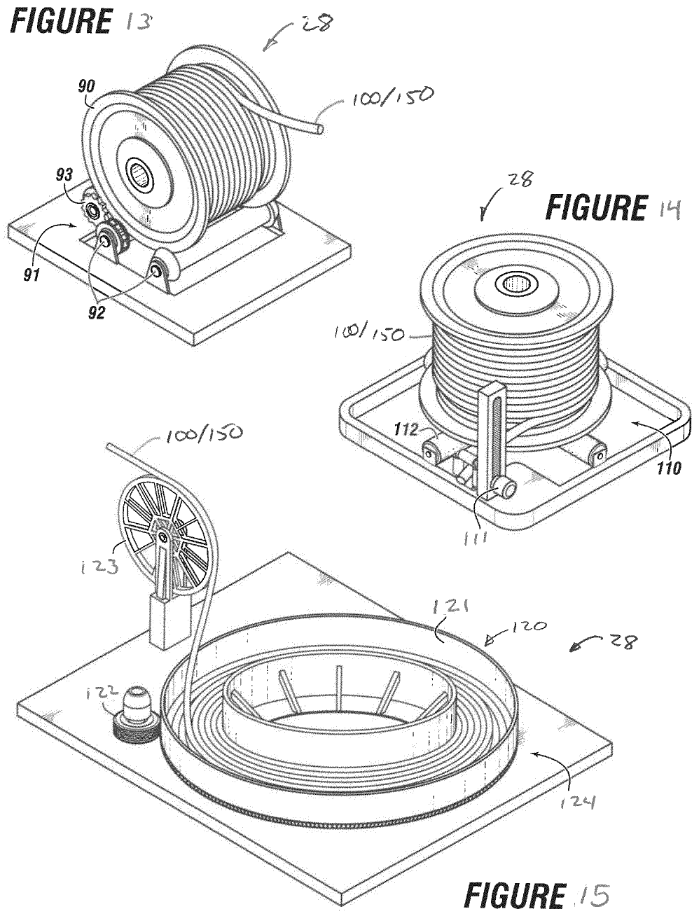

FIG. 14 depicts an illustrative collection and deployment module 28 configured as a horizontal carousel 110 in an isometric view according to one or more embodiments. The horizontal carousel 110 can have a level wind 111 and a rotating means 112.

FIG. 15 depicts an illustrative collection and deployment module configured as a basket carousel 120 in an isometric view according to one or more embodiments. The basket carousel 120 can have a basket 121, a drive mechanism 122 a spooling reel 123 according to some embodiments. The basket carousel 120 can have a foundation 124.

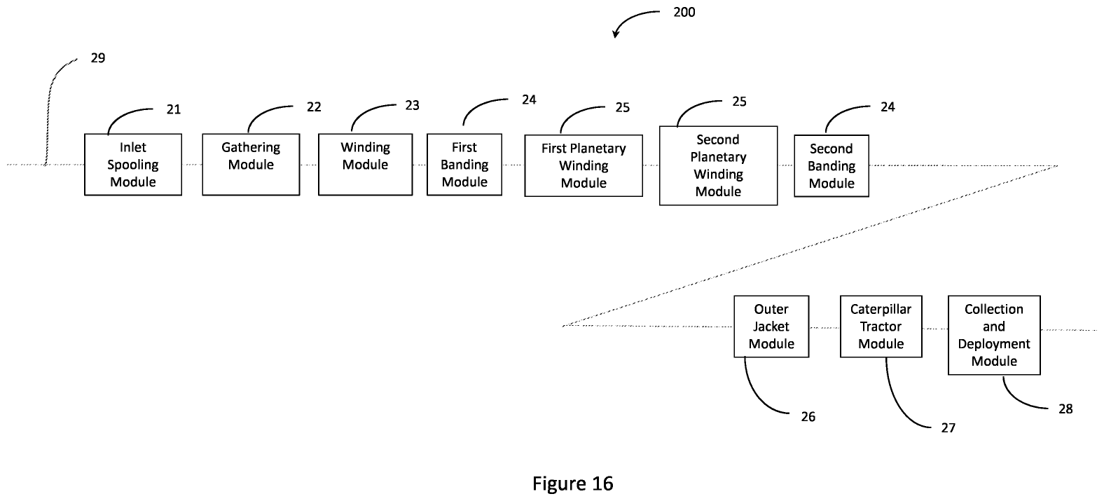

FIG. 16 depicts a second illustrative modular and deployable marine power cable manufacturing system 200 in plan view according to one or more embodiments described. The modular deployable marine cable manufacturing system 200, hereinafter referred to as the system, can comprise any number of production modules arranged and distributed among a plurality of deployable modules and can also optionally comprise a number of foundation modules not shown on which the production modules can sit upon at a construction site. The production modules can be arranged along a longitudinal axis 29 and are arranged in a particular order according to the specific marine power cable manufacturing sequence when deployed at the construction site. The various production modules can include an inlet spooling module 21, a gathering module 22, a winding module 23, a first banding machine 24, a first planetary winding module 25, a second planetary winding module 26, a second banding machine 24, an outer jacket module 26, a caterpillar tractor module 27 and a collection and deployment module 28 and can be arranged according to the component listed. In other embodiments, the system 20 can include an inlet spooling module 21, a gathering module 22, a winding machine 70, a first banding machine 24, and a caterpillar tractor 27 wherein the winding machine 70, the first banding machine 24 are disposed a single deployable module, not shown. In other embodiments, the winding machine 70 is disposed on a plurality of modules, not shown.

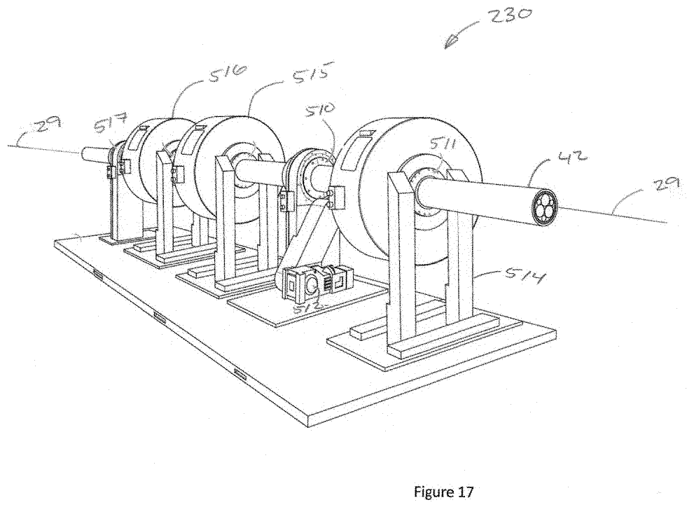

FIG. 17 depicts an illustrative winding module 230 having an optional guide 517 and an optional first taping machine 515 and an optional second taping machine 516 in an isometric view according to one or more embodiments. The winding module 230 can be the next module in the system 20 after the gathering module 22 and the bundle 42 can advance from the gathering module 22 to the winding module 230. The winding module 230 can include a revolving plate 510 and a static plate 511. The revolving plate 510 and the static plate 511 can be oriented substantially perpendicular to the longitudinal axis 29. The revolving plate 510 and static plate 51 can each have an opening that is complementary to the cross-sectional shape of the bundle such that the revolving plate 510 and static plate 511, can impart a torsional force to rotate or twist the bundle 42. The revolving plate 510 can be fitted to an electrical, hydraulic motor or other means 512 of rotating or turning the revolving plate 510 relative to the static plate 511. The revolving plate 510 can be configured to revolve clockwise for a plurality of rotations, and then counterclockwise for a plurality of rotations in an alternating fashion thus winding the bundle 42 into an alternating helical configuration as the bundle 42 passes through the winding machine 23. Both the static plate 511 and revolving plate 510 can be mounted on stands or pedestals 514 within the winding module 230. The stands or pedestals 514 can be mounted on a deployable module 55. The revolving plate 50 can rotate at a rate that is known to those skilled in the art and commensurate with the selected design of the marine power cable being manufactured. Typical rotation or winding rates range from one revolution every 0.5 meters of cable length on up to one revolution every 3-5, or one revolution every 6-10 meters or greater depending upon the specific design of the marine power cable. In some embodiments the optional first and optional second taping machines 515 and 516 can be substantially similar to the taping machine 60 depicted on FIG. 9.

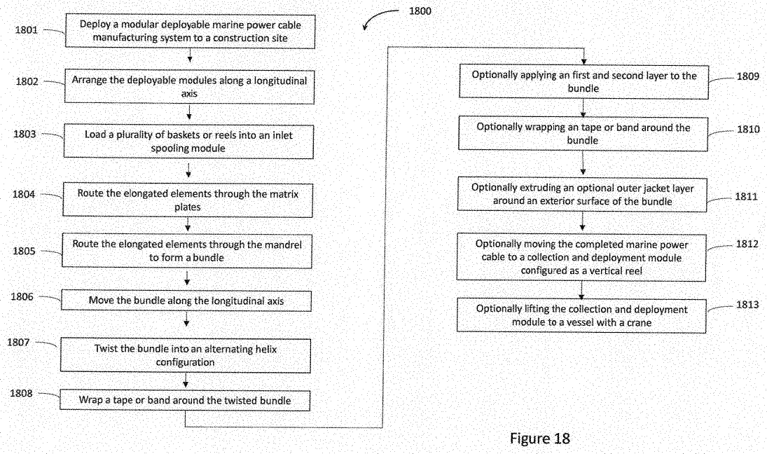

FIG. 18 depicts an outline method 1800 for manufacturing a marine power cable according to some embodiments. The method for manufacturing a marine power cable can include the steps of deploying a modular, deployable marine power cable manufacturing system to a construction site 1801, arranging the plurality of deployable modules along a longitudinal axis 1802, loading a plurality of baskets and/or reels containing a plurality of elongated elements onto the inlet spooling module 1803, routing the plurality of elongated elements from the baskets and/or reels through the plurality of openings defined by the matrix plate 1804, routing the plurality of elongated elements through the mandrel to gather the elongated elements into a bundle 1805, moving the bundle in a direction towards the caterpillar tractor 1806, twisting the bundle into an alternating helical configuration; and 1807 wrapping a helically wound tape or banding material around the outside of the bundle 1808. The method can also include the optional step of applying an optional first layer and an optional second layer of helically arranged strings and/or helically arranged metallic wires to the bundle 1809. The method can also include the optional step of wrapping a band or tape material around the outside of the bundle 1810. The method can also include the optional step of extruding an outer jacket layer around an exterior surface of the bundle 1811. The method can also include the optional step of manufacturing the marine power cable directly onto a collection and deployment module 1812. The collection and deployment module can be configured as a vertical reel. The method can also include the optional step of lifting the vertical onto a vessel with a crane 1813.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A modular, deployable marine power cable manufacturing system for manufacturing a marine power cable wherein the marine power cable comprises a plurality of elongated elements and the system is arranged in the following component sequence along a longitudinal axis, comprising:
an inlet spooling module configured to receive a plurality of baskets and/or a plurality of reels, wherein each basket and/or reel of the plurality of baskets and/or reels contains an elongated element and wherein the rack, the reels, or the baskets are configured to deploy the elongated elements;
a gathering module comprising a matrix plate and a mandrel, wherein the matrix plate defines a plurality of openings configured to receive and direct the elongated elements towards the mandrel and the mandrel is configured to circumscribe and gather the plurality of elongated elements into a bundle such that the plurality of elongated elements is substantially parallel to and adjacent to one another;
a winding module comprising a static plate and a revolving plate configured to twist the bundle in an alternating helical configuration;
a first banding machine configured to wrap a band or tape around the bundle; and
a caterpillar tractor configured to pull the bundle along the longitudinal axis, wherein the inlet spooling module, the gathering module, the winding module, the first banding machine, and the caterpillar tractor are configured to be disposed on a plurality of deployable modules.

2. The system of claim 1 wherein the plurality of elongated elements comprises at least one power cable, one electric wire, one optical conduit, or one filler string and the plurality of elongated elements does not include an elongated element configured to convey a fluid.

3. The system of claim 1 further comprising a first planetary winding module wherein the first planetary winding module is configured to be disposed on at least one of the deployable modules and the first planetary winding module is configured to apply a first layer to the bundle wherein the first layer comprises a plurality of strings or a plurality of metallic wires, by winding the plurality of strings or the plurality of metallic wires in a helical arrangement around the bundle.

4. The system of claim 3 further comprising a second planetary winding module wherein the second planetary winding module is configured to be disposed on at least one of the deployable modules and the second planetary winding module is configured to apply a second layer to the bundle wherein the second layer comprises a plurality of strings or a plurality of metallic wires, by winding the plurality of strings or the plurality of metallic wires in a helical arrangement around the bundle.

5. (canceled)

6. The system of claim 1 further comprising a jacket extruding machine wherein the jacket extruding machine is configured to be disposed on at least one of the deployable modules and configured to extrude an outer jacket layer comprising a thermoset or thermoplastic material around an outer surface of the bundle.

7. The system of claim 1 further comprising a collection and deployment module and wherein the collection and deployment module comprises a vertical reel, a basket carousel, or a horizontal carousel.

8. The system of claim 1 wherein the deployable modules are configured to be transported via standard semi-tractor trailers and/or wherein the deployable modules are configured within shipping containers.

9. The system of claim 1 wherein the static plate and the revolving plate are each oriented substantially perpendicular to the longitudinal axis wherein the static plate and revolving plate each define an opening that is complementary to the cross-sectional shape of the bundle such that the revolving plates and static plates are configured to impart a torsional force to the bundle to rotate or twist the bundle as the bundle is moved along the longitudinal axis.

10. A method for manufacturing a marine power cable comprising:
deploying a modular, deployable marine power cable manufacturing system to a construction site, the system comprising: an inlet spooling module configured to receive a plurality of baskets and/or a plurality of reels, wherein each basket and/or reel of the plurality of baskets and/or reels contains an elongated element and wherein the inlet spooling module and the reels and/or the baskets are configured to deploy the elongated elements from the baskets and/or reels, a gathering module comprising a matrix plate and a mandrel, wherein the matrix plate defines a plurality of openings configured to receive and direct the elongated elements towards the mandrel and the mandrel is configured to circumscribe and gather the plurality of elongated elements into a bundle such that the plurality of elongated elements are substantially parallel to and adjacent to one another, a winding module comprising a static plate and a revolving plate configured to twist the bundle in an alternating helical configuration, a first banding machine configured wrap a band or tape around the bundle, and a caterpillar tractor configured to pull the bundle along the longitudinal axis, wherein the inlet spooling module, the gathering module, the winding machine the first banding machine, and the caterpillar tractor are disposed on a plurality of deployable modules;
arranging the plurality of deployable modules along a longitudinal axis;
loading a plurality of baskets and/or reels containing a plurality of elongated elements onto the inlet spooling module;
routing the plurality of elongated elements from the baskets and/or reels through the plurality of openings defined by the matrix plate;
routing the plurality of elongated elements through the mandrel to gather the elongated elements into a bundle;
moving the bundle in a direction towards the caterpillar tractor;
twisting the bundle into an alternating helical configuration; and
wrapping a helically wound tape or banding material around the outside of the bundle.

11. The method of claim 10 wherein the plurality of elongated elements comprises at least one power cable, one electric wire, one optical conduit, or one filler string and excludes an elongated element configured to convey a fluid.

12. The method of claim 11 further comprising applying a first layer and optionally a second layer of helically arranged strings and/or helically arranged metallic wires to the bundle wherein the system further comprises a first planetary winding machine and an optional second planetary winding machine configured to apply a first layer and an optional second layer to the bundle by winding a plurality of strings or a plurality of metallic wires in a helical arrangement around the bundle.

13. The method of claim 12 wherein the marine power cable comprises a first layer and second layer and the first layer is applied in a clockwise helical arrangement and the second layer is applied in a counterclockwise helical arrangement or the first layer is applied in a counterclockwise helical arrangement and the second layer is applied in a clockwise helical arrangement.

14. The method of claim 13 further comprising wrapping a band or tape material around the outside of the bundle wherein the system comprises a second banding machine.

15. The method of claim 10 further comprising extruding an outer jacket layer around an exterior surface of the bundle wherein the outer jacket layer comprises a thermoset or thermoplastic material and wherein the system further comprises a jacket extruding machine.

16. The method of claim 10 further comprising moving the marine power cable directly onto the collection and deployment module wherein the collection and deployment module comprises a vertical reel, a basket carousel, or a horizontal carousel.

17. The method of claim 13 wherein the first layer and the second layer each comprise a plurality of metallic wires and wherein the second layer is wound in a direction opposite of first layer winding direction.

18. The method of claim 16 wherein the collection and deployment module is a vertical reel, wherein a completed marine power cable is disposed on the vertical reel, comprising lifting the vertical onto a vessel with a crane.

19. A modular, deployable marine power cable manufacturing system for manufacturing a marine power cable wherein the marine power cable comprises a plurality of elongated elements and the system is arranged in the following component sequence along a longitudinal axis, comprising:
an inlet spooling module configured to receive a plurality of baskets and/or a plurality of reels, wherein each basket and/or reel of the plurality of baskets and/or reels contains an elongated element and wherein the rack, the reels, or the baskets are configured to deploy the elongated elements;
a gathering module comprising a matrix plate and a mandrel, wherein the matrix plate defines a plurality of openings configured to receive and direct the elongated elements towards the mandrel and the mandrel is configured to circumscribe and gather the plurality of elongated elements into a bundle such that the plurality of elongated elements is substantially parallel to and adjacent to one another;
a winding module comprising a static plate and a revolving plate configured to twist the bundle in an alternating helical configuration;
a first banding machine configured wrap a band or tape around the bundle; and
a first planetary winding machine and a second planetary winding machine wherein the first and second planetary winding machines are configured to apply a first layer and a second layer to the bundle wherein the first and second layers comprise a plurality of strings or a plurality of metallic wires, by winding the plurality of strings or the plurality of metallic wires in a helical arrangement around the bundle;
a second banding machine wherein the second banding machine is configured to be disposed on at least one of the deployable modules and configured to wrap a band or tape around the bundle; and
a jacket extruding machine wherein the jacket extruding machine is configured to extrude an outer jacket layer comprising a thermoset or thermoplastic material around an outer surface of the bundle; and
a caterpillar tractor configured to pull the bundle along the longitudinal axis; wherein the inlet spooling module, the gathering module, the winding module, the first banding machine, the first and second planetary winding machines, the second banding machine, the jacket extruding machine and the caterpillar tractor are configured to be disposed on a plurality of deployable modules, the plurality of elongated elements comprises at least one power cable, one electric wire, one optical conduit, or one filler string and the plurality of elongated elements does not include an elongated element configured to convey a fluid, and the static plate and the revolving plate are each oriented substantially perpendicular to the longitudinal axis, the static plate and revolving plate each define an opening that is complementary to the cross-sectional shape of the bundle such that the revolving plate and static plate are configured to impart a torsional force to the bundle to rotate or twist the bundle as the bundle is moved along the longitudinal axis.

20. The system of claim 3 further comprising a second banding machine wherein the second banding machine is configured to be disposed on at least one of the deployable modules and configured to wrap a band or tape around the bundle.

21. The system of claim 4 further comprising a second banding machine wherein the second banding machine is configured to be disposed on at least one of the deployable modules and configured to wrap a band or tape around the bundle.
